(19) United States
(12) Patent Application Publication
(10) Pub. No.: US 2013/0239060 A1
(43) Pub. Date: Sep. 12, 2013

(54) METHOD AND APPARATUS TO PROVIDE SHORT-CUT ICON

(71) Applicant: PANTECH CO., LTD., Seoul (KR)

(72) Inventors: Moon-Key KANG, Anyang-si (KR); Hoo-Dong LEE, Seoul (KR)

(73) Assignee: PANTECH CO., LTD., Seoul (KR)

(21) Appl. No.: 13/658,279

(22) Filed: Oct. 23, 2012

(30) Foreign Application Priority Data
Mar. 7, 2012 (KR) 10-2012-0023225

(51) Int. Cl. G06F 3/048

(52) U.S. Cl. 715/835

(57) ABSTRACT

An apparatus and method for providing a short-cut icon for an application in a portable device is disclosed. The short-cut icon provides information related to the application as well as an application launching icon. The information related to the application may include other applications which can execute the content of the application, a browser to search for information about the application, a location of the content of the application, etc.

### CROSS-REFERENCE TO RELATED APPLICATION

This application claims priority from and the benefit under 35 U.S.C. §119(a) of Korean Patent Application No. 10-2012-0023225, filed on Mar. 7, 2012, which is incorporated by reference for all purposes as if fully set forth herein.

### BACKGROUND

1. Field

The following description relates to user interface technology, and more particularly, to user interface technology that provides a short-cut icon.

2. Discussion of the Background

With the development of information and communication technologies, the types of electronic apparatuses available have increased. For example, a cellular phone, an MP3 is player, a digital camera, a portable multimedia player (PMP), a navigation, a portable game machine, an electronic dictionary, an E-book reader, and a digital multimedia broadcasting (DMB) receiver are all electronic apparatuses available to the consuming public. The use of portable devices, such as tablet computers, smart phones, and smart pads, has increased rapidly.

To increase the mobility or portability of portable devices, the sizes thereof may be reduced. However, the reduction in the size of portable device may limit operations the portable devices. A method that can operate the portable devices may include a method using a hardware key, a touch screen, or motion capture device mounted on the devices. The operating method of a portable device may have many limitations compared with an operating method used in a PC. Multi-processing is basically supported on the PC because a plurality of applications may be brought up on a screen through a wide display, an interlocking work among the applications can be performed. However, it is not easy to perform interlocking work on a portable device while displaying the plurality of applications on one screen.

A method of processing contents in the portable device may include the following methods. A method in which each application shows to a user a list of contents which the corresponding application can process and processes contents selected by the user In detail, a method in which each application lists contents such as music or video which each application itself can process and processes the contents selected by the user among them. A method of processing the contents by transmitting an executing request for the contents selected by a user in a list provided from a file management application (e.g., a file manager, a file explorer, and the like) to an operating system, and driving the application capable of processing the corresponding content in the operating system. A method in which the contents are transferred in a predetermined message type from a predetermined application to another application in the operating system to allow the corresponding contents to be processed in another application. For example, if the contents are inserted into an attachment file of an e-mail in a first application and transferred to a second application, the second application can use the contents inserted into the attachment file.

The aforementioned methods may be used limitedly in an application capable of processing the corresponding contents while using the contents, and may require a user to perform multiple operations, such as launching the applications to execute the contents.

### SUMMARY

Exemplary embodiments of the present invention provide a method and an apparatus to provide a short-cut icon.

Exemplary embodiments of present invention also provide a method for executing content of a short-cut icon.

Additional features of the invention will be set forth in the description which follows, and in part will be apparent from the description, or may be learned by practice of the invention.

An exemplary embodiment of the present invention discloses {A portable device, including: a short-cut icon generating unit configured to generate a short cut icon of a first application; a user interface configured to display the short-cut icon, wherein if the short-cut icon is selected, the user interface displays a menu of at least one of a content of the first application, a launch application icon, a launch browser icon, a file manager icon, and an application list of other applications that execute the content of the first application.

An exemplary embodiment of the present invention also discloses a method for providing a short-cut icon, including: receiving a request to generate a short-cut icon for a first application; collecting content attribute information of the first application; generating a short-cut icon of the first application according to content attribute information of the first application; and displaying the short-cut icon, wherein the short-cut icon includes a the content of the first application and content attribute information of the first application not used to execute the first application.

An exemplary embodiment of the present invention also discloses a method of executing a short-cut icon in a portable device, including: selecting a short-cut icon of a first application; moving the short-cut icon to be disposed on a second short-cut icon of a second application; executing a content of the first application according to the second application, wherein the short-cut icon includes a the content of the first application and content attribute information of the first application not used to execute the first application.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram of a portable device according to an exemplary embodiment of the present invention.

FIG. 2 is a diagram of a short-cut icon generating unit according to an exemplary embodiment of the present invention.

FIG. 3 is a flowchart of a method for operation of a user interface controlling unit according to an exemplary embodiment of the present invention.

FIG. 4 is a diagram of an item list displayed on a user interface unit according to the exemplary embodiment of the present invention.

FIG. 5 is a diagram illustrating a screen displaying an item list according to an exemplary embodiment of the present invention.

FIG. 6 is a diagram illustrating a screen illustrating an item list according to an exemplary embodiment of the present invention.

FIG. 7 is a flowchart of a method for operation of a data collecting according to an exemplary embodiment of the present invention.

FIG. 8 is a flowchart of a method for data collection according to an exemplary embodiment of the present invention.

FIG. 9 is a diagram of content attribute information according to an exemplary embodiment of the present invention.

FIG. 10 is a diagram of a data processing unit according to an exemplary embodiment of the present invention.

FIG. 11 is a flowchart of a method for operation of a data analyzing unit and a short-cut icon registering unit according to an exemplary embodiment of the present invention.

FIG. 12 is a diagram of a table preparation method according to an exemplary embodiment of the present invention.

FIG. 13 is a flowchart of a method for operation of an icon generating unit and a short-cut icon placing unit according to an exemplary embodiment of the present invention.

FIG. 14 is a diagram of a screen displaying short-cut icons according to an exemplary embodiment of the present invention.

FIG. 15 is a diagram of a portable device according to an exemplary embodiment of the present invention.

FIG. 16 is a diagram of a short-cut icon activity managing unit and a data selection managing unit according to an exemplary embodiment of the present invention.

FIG. 17 is a diagram of short-cut icon attribute information according to an exemplary embodiment of the present invention.

FIG. 18 is a diagram of a method for generating an application list according to an exemplary embodiment of the present invention.

FIG. 19 is a diagram of a screen according to an exemplary embodiment of the present invention.

FIG. 20 is a diagram of a screen according to an exemplary embodiment of the present invention.

FIG. 21 is a diagram of a screen according to an exemplary embodiment of the present invention.

FIG. 22 is a method for executing contents according to an exemplary embodiment of the present invention.

### DETAILED DESCRIPTION OF THE ILLUSTRATED EMBODIMENTS

Exemplary embodiments are described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element, it can be directly on or directly connected to the other element, or intervening elements may be present. In contrast, when an element is referred to as being “directly connected to” another element, there are no intervening elements present. It will be understood that for the purposes of this disclosure, “at least one of X, Y, and Z” can be construed as X only, Y only, Z only, or any combination of two or more items X, Y, and Z (e.g., XYZ, XYY, YZ, ZZ). Although features may be shown as separate, such features may be implemented together or individually. Further, although features may be illustrated in association with an exemplary embodiment, features for one or more exemplary embodiments may be combinable with features from one or more other exemplary embodiments

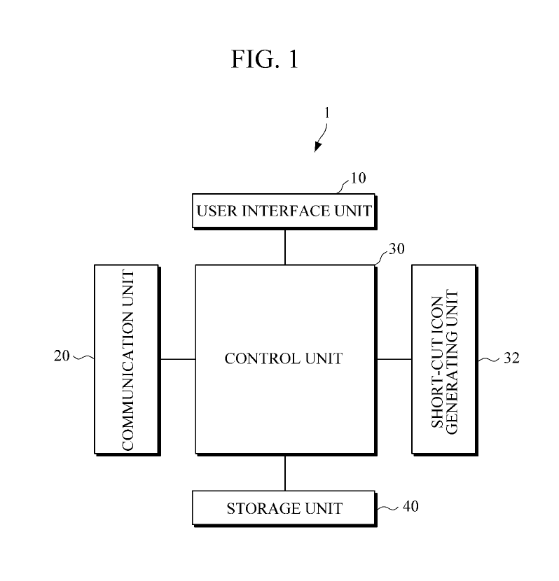

FIG. 1 is a diagram of a portable device according to an exemplary embodiment of the present invention.

A portable device 1 includes a user interface unit 10, a communication unit 20, a control unit 30, a storage unit 40, and a short-cut icon generating unit 32.

The user interface unit 10 may be configured as an input/output unit for interactions between a user and the device 1. The user may input commands or data to the device 1 through the user interface unit 10, and the device 1 may output information or data to the user through the user interface unit 10. The user interface unit 10 may include sound input/output units, such as a microphone and a speaker, and a display unit for inputting/outputting graphics or texts. The display unit may be a touch screen and the touch screen may have a structure in which a touch pad (input unit) and a display (output unit) are combined with each other, or a structure in which both units are integrally formed with each other.

The communication unit 20 may be configured to transmit data to or receive data from other user terminals or service servers through networks. The networks may be a wired network or wireless network. The device 1 may download and install a new application by accessing an application market through the communication unit 20. The type of network which the communication unit 20 may be configured to transmit to or receive data from a variety of networks, for example a mobile communication network, a Wi-Fi network, Wi-Bro® network, etc.

The control unit 30 is configured to manage and control the device 1. For example, the control unit 30 may control and process interactions with external devices, such as data communication or a voice call, a video call, and the like, and control or process a reference application in the device 1, such as a game or multimedia playing. The control unit 30 may be configured to process data or signals received through the user interface unit 10 and store the input data in the storage unit 40, and may control reference data or reference signals to be output through the user interface unit 10.

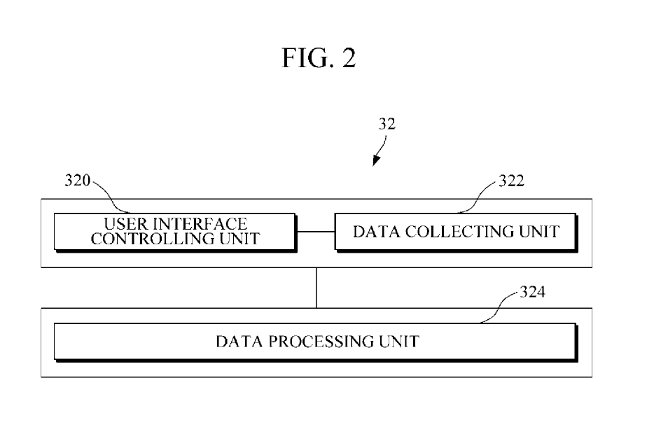

The short-cut icon generating unit 32 may be configured to generate a short-cut icon and to display the generated short-cut icon on the user interface unit 10. The short-cut icon may be disposed on the home screen of the user interface unit 10. The short-cut icon may be a graphical user interface (GUI) configured to allow the user to execute the contents of an application directly without launching the application. The user may access the contents of the application by using the short-cut icon. The short-cut icon generating unit 32 may be configured to acquire information, process signals, manage information, and calculate information to generate the short-cut icon. The short-cut icon generating unit 32 will be described in detail with reference to FIG. 2.

The storage unit 40 may be configured to store data in the device 1. The storage unit 40 may be configured to store an operating system, an application, and data. The applications may be preinstalled in the device 1 or downloaded to the device 1. The data may include data downloaded into the device 1 such as texts, images, sound, moving picture, etc. The storage unit 40 may store information associated with the application preinstalled or downloaded in the device 1, e.g., data associated with a name, an executable function, a supported function, and the like of each application. The storage unit 40 may be configured to store data to generate the short-cut icon, or a database of the data acquired by generating the short-cut icon. The database may be stored as a table but is not limited thereto.

FIG. 2 is a diagram of the short-cut icon generating unit according to an exemplary embodiment of the present invention.

Referring to FIG. 2, the short-cut icon generating unit 32 includes a user interface controlling unit 320, a data collecting unit 322, and a data processing unit 324.

The user interface controlling unit 320 and the data collecting unit 322 may be performed in an application terminal if the application may be launched in a device software configuration, and the data processing unit 324 may be performed on a framework terminal, but the present invention is not limited thereto.

The user interface controlling unit 320 may be configured to provide an item list. The item list may be a content displaying unit of a launched application. A user event may be detected in the provided item list. The data collecting unit 322 may be configured to collect information to generate a short-cut icon for a user selected item through the user interface controlling unit 320. The data processing unit 324 may generate a short-cut icon to directly execute content by using information collected by the data collecting unit 322.

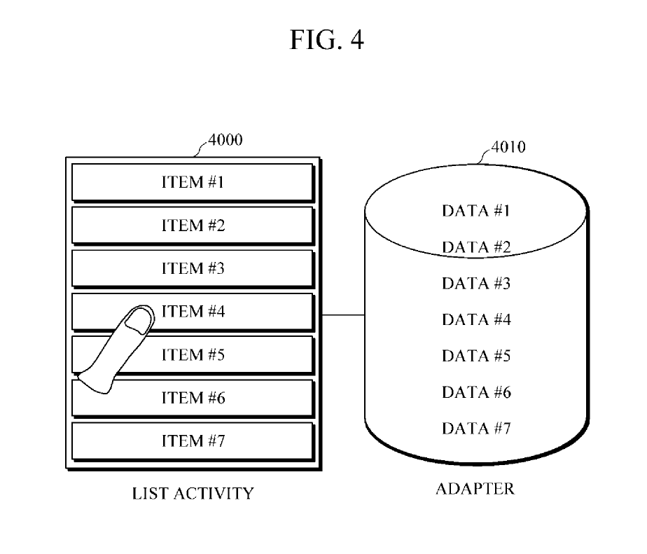

The user interface controlling unit 320 is configured to display the item list on the screen if the application is launched. For example, if the application is a music player, an item list of contents which may be executed in the music player may be displayed on the screen. The item list suitable for types, an arrangement method, and a conditional equation of the contents may be stored in a reference structure and may be displayed on the screen in a selected type by using the structure information. The item list may be displayed through a list activity and an adapter. The list activity may be a component configured to display list objects on a screen of the device 1. The adapter may be a component configured to transfer data provided by the adapter to an adapter view. The adapter view may be a graphic object that initializes a view group and a child view and may be expressed from the data provided by the adapter. The list activity and the adapter will be described below in detail in FIG. 4.

The user interface controlling unit 320 is configured to receive a selection of a reference item in the item list by detecting the user event, and to extract an index by determining whether data for the selected item is present. The index may be position information of the items in the item list. The index may be reference information to verify and search the selected reference item on the item list.

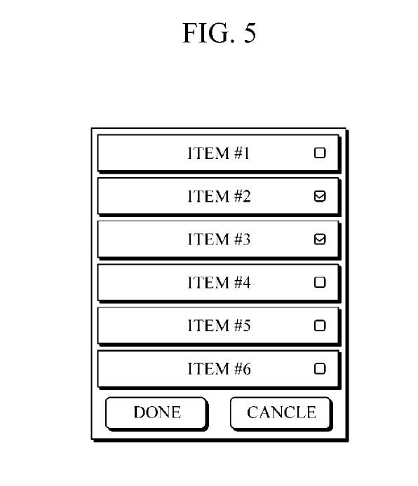

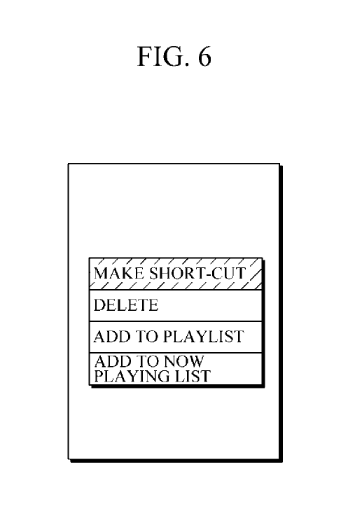

A method may be used within the application in order to detect the user event and for example. A reference item may be selected through an option menu configured to receive a user selection, for example, through a long touch, etc., and will be described below in FIG. 5 and FIG. 6.

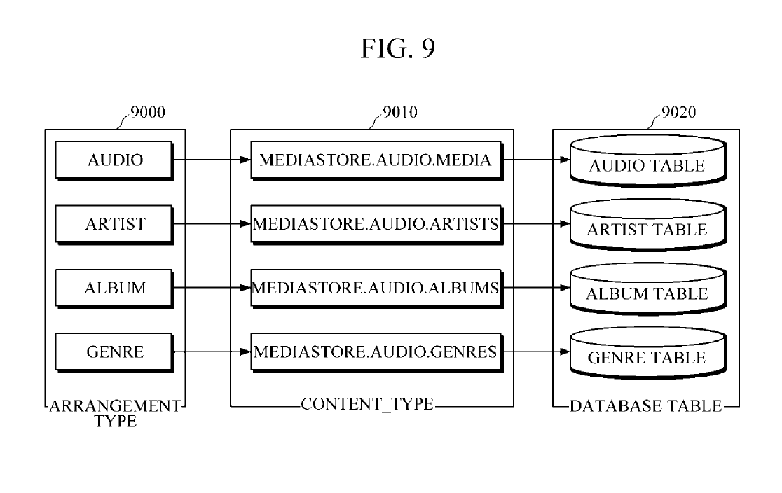

The data collecting unit 322 may be configured to receive a data collection request message including the index extracted from the user interface controlling unit 320, to collect content attribute information (metadata) to connect a database table storing the content data with an item selected by the user. The content attribute information may be data granted to contents according to a reference rule in order to find data in a large quantity of data. The data processing unit 324 may receive the content attribute information from the data collecting unit 322 to search reference data required to generate the short-cut icon by using the content attribute information. An exemplary embodiment of the content attribute information will be described below in FIG. 9.

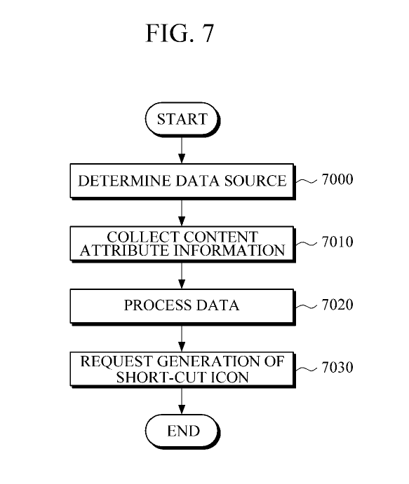

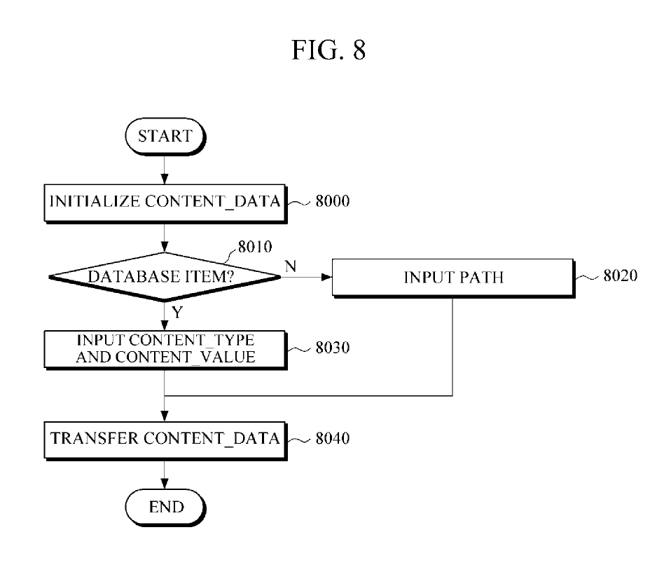

The data collecting unit 322 may be configured to use an index of the reference item selected within the item list received from the user interface controlling unit 320 to collect content attribute information matched with the index. The data may be data acquired through a query of the database table or a file route of a file system. The data collecting unit 322 may be configured to process and package the collected content attribute information in a data type which the data processing unit 324 can analyze. A transfer message may be prepared to suit a message transfer mechanism provided in the operating system in order to transfer the packaged data, and a short-cut icon registration request message may be transmitted to the data processing unit 324 together with the transfer message. A method for operation of the data collecting unit 322 will be described below in FIG. 7 and FIG. 8.

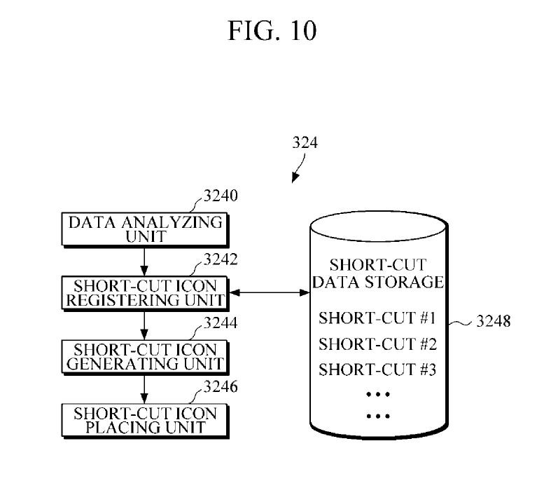

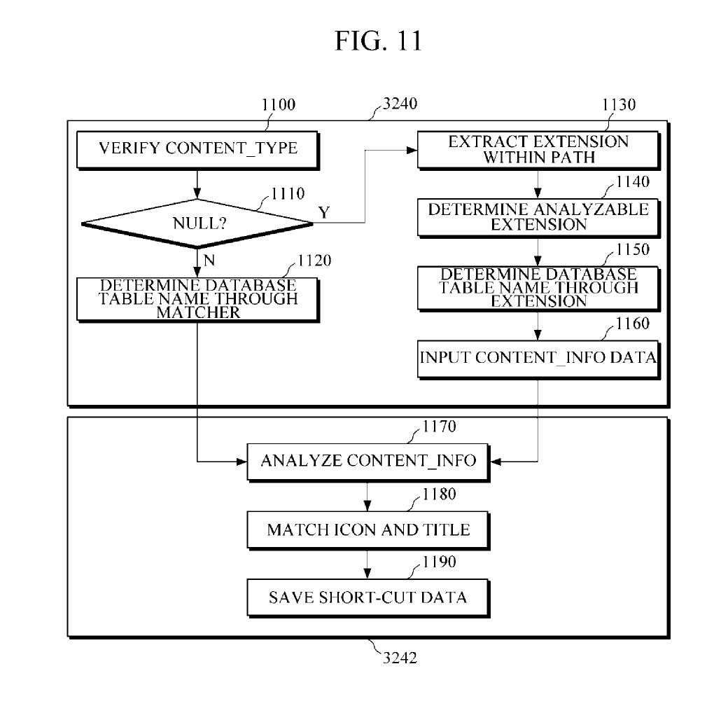

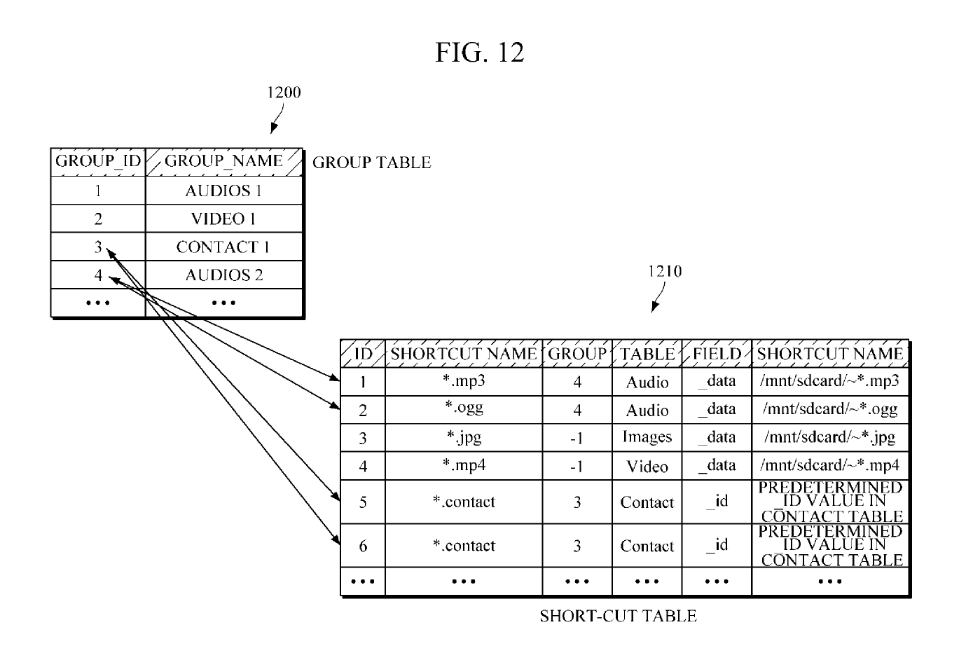

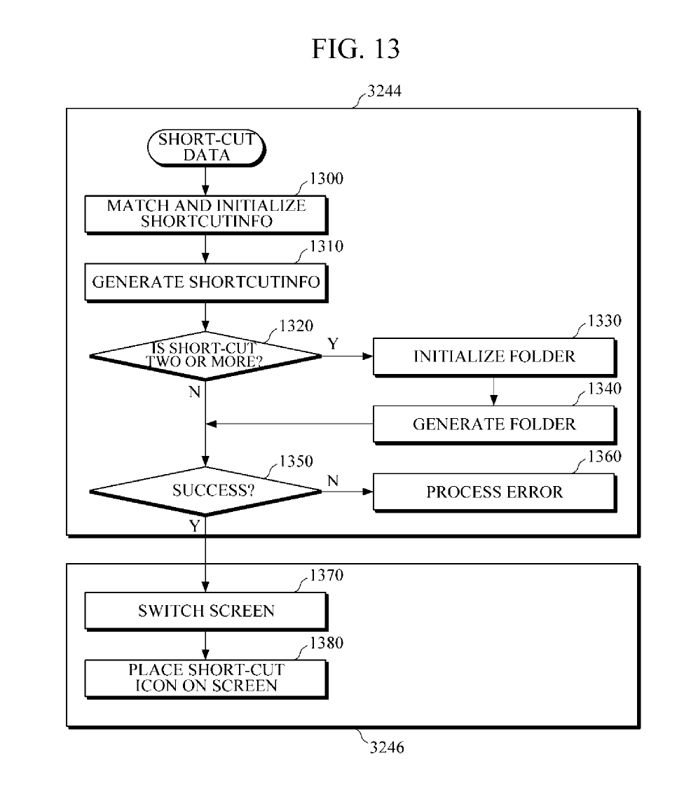

The data processing unit 324 may be configured to perform operations such as data analysis and icon matching to generate the short-cut icon by analyzing the registration request message and information received from the data collecting unit 322. New data may be added to a short-cut data table managed by the data processing unit 324 to be managed in order to manage contents which can be added to a short-cut by generating the short-cut icon. The short-cut icon may be disposed in the user interface unit 10 and may be disposed on an area which the user can access, e.g., the home screen of the device. A detailed configuration of and a method for the operation of the data processing unit 324 will be described below in FIG. 10 and in FIG. 11, FIG. 12, and FIG. 13.

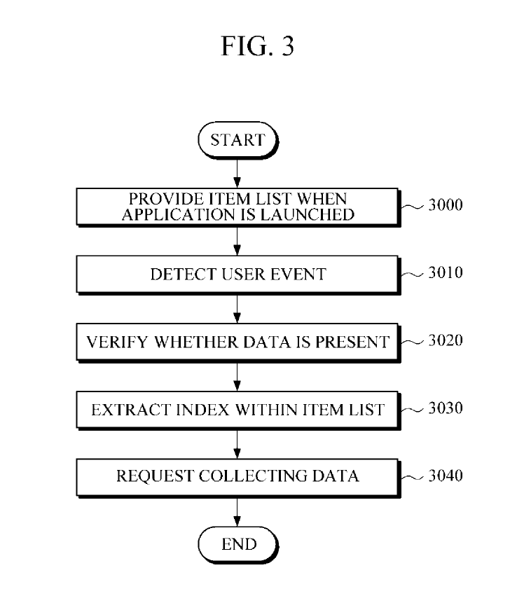

FIG. 3 is a flowchart of a method for operation of a user interface controlling unit according to an exemplary embodiment of the present invention.

Although described as performed by the features of FIG. 2, the features of the method of FIG. 3 are not limited thereto. In operation 3000, an application may be launched to actuate the user interface controlling unit 320 to display the item list on a display of device 1. In operation 3010, a user event is detected, and the user event is recognized as a user request to generate the short-cut icon. The user event may be any event suitable for an item or an application selected from the item list.

In operation 3020, the user interface controlling unit 320 determines whether data of the selected item or selected application is present. If the data is present, in operation 3030, the index is extracted. The extracted index may be used to collect data that is matched with the item list. The data may be matched on a one-to-one basis with the items of the item list, but is not limited thereto. In operation 3040, the user interface controlling unit 320 requests a data collection operation from the data collecting unit 322 by transferring a data collection request message and the extracted index to the data collecting unit.

FIG. 4 is a diagram of an item list displayed on a user interface unit according to the exemplary embodiment of the present invention.

Although described as performed by the features of FIG. 1, the features of FIG. 4 are not limited thereto. The item list may have various shapes. For example, the item list may include a list activity 4000 configured to receive user input and to transmit output and an adapter 4010 including a plurality of data, Data #1, Data #2, . . . , Data #n corresponding to items listed in the list activity 4000, i.e., Item #1, Item #2, . . . , Item #n. The data in the adapter may be used to configure the item list of the list activity 4000.

The launched application may prepare data suitable for a data type of the adapter 4010 and may transmit the prepared data to the adapter 4010 to configure the item list. The adapter 4010 may generate an object to configure each item within the list activity 4000 and may configure the items of each list activity 4000 by analyzing data of the adapter 4010. An operating system of the device 1 may transmit a corresponding event to a process which may be disposed at an uppermost layer among a plurality of processes if the user input is detected. The list activity 4000 may recognize the corresponding event to transfer the corresponding event to an upper activity with an index number of the item selected by the user on the item list. The upper activity may extract desired information from the data allocated to the adapter 4010 through the received index number.

FIG. 5 is a diagram illustrating a screen displaying an item list according to an exemplary embodiment of the present invention. FIG. 6 is a diagram illustrating a screen displaying an item list according to an exemplary embodiment of the present invention.

The user interface controlling unit 320 may provide a method for selecting a single or multiple items by using a method of selectively receiving, from the user, an item from the item list for which the short-cut icon may be generated.

For example, referring to FIG. 5, the user may select a single item through a click operation including a short click or long click on the item list. Since a function of the corresponding application may generally be performed in response to a short click operation on the item list, the single item may be selected through the long click operation as shown in FIG. 5. The user interface (UI) for selecting multiple items at a time may select the plurality of items by allocating a check box to each item as shown in FIG. 5. Referring to FIG. 6, if the user performs a long click operation, an option menu may be provided to a user. A user may select a reference item of the option menu as shown in FIG. 6. The option menu of FIG. 6 provides a user with items to “MAKE A SHORT-CUT,” “DELETE,” “ADD TO PLAYLIST,” and “ADD TO NOW PLAYING LIST.”

FIG. 7 is a flowchart of a method for operation of a data collecting unit according to an exemplary embodiment of the present invention.

Although FIG. 7 will be described with reference to the features of FIG. 2, the exemplary embodiments are not limited thereto. In operation 7000, the data collecting unit 322 determines a data source of the item from the index of the item received from the user interface controlling unit 320. The data source may be information acquired from the database table or the file system. The data source may be used to extract a name of the database table in the data processing unit 324.

In operation 7010, the data collecting unit 322 collects the content attribute information to generate the short-cut icon in the data processing unit 324. In operation 7020, the data collecting unit 322 processes the collected content attribute information according to a type which the data processing unit 324 may analyze. In operation 7030, the data collecting unit 322 requests generation of the short-cut icon. In detail, the data collecting unit 322 may prepare a transfer message to request generation of the short-cut icon according to a message exchange rule from the operating system, and may transfer the prepared transfer message to the data processing unit 324.

The data collecting unit 322 collects the content attribute information for the data processing unit 324 to generate the short-cut icon for the item selected by the user. The content attribute information may have a structure shown in Table 1 below to include CONTENT_TYPE and CONTENT_VALUE.

TABLE 1

| Value | Type | Description |
|---|---|---|
| CONTENT_TYPE | String | CONTENT_TYPE as a reference value in an |
| | | operating system and is reference value which may |
| | | be accessible in a plurality of processes. The |
| | | plurality of processes may acquire information on |
| | | contents that are present on a device while |
| | | maintaining compatibility with another process |
| | | through the same interface with the value (e.g.,: |
| | | MediaStore_Audio.Media). |
| CONTENT_VALUE | CONTENT_INFO | CONTENT_VALUE is one structure including a |
| | | value capable of identifying corresponding contents. |
| | | Data included in the structure may be a value of a |
| | | reference field of a database table and may be a file |
| | | route within a file system. |

CONTENT_INFO may be configured in a structure as shown in Table 2 below.

TABLE 2

| Value | Type | Description |
|---|---|---|
| Field | String | Contains a name of a reference field within the database |
| | | (e.g.: _data, _id). |
| Field_Value | Object following | Contains content corresponding to the reference field. |
| | a data type of a | Other information corresponding to contents selected by a |
| | reference field | user can be extracted by using the value |
| | value | (e.g.: /mmt/sdcard/sample.mp3). |

FIG. 8 is a flowchart of a method for data collection according to an exemplary embodiment of the present invention.

Although FIG. 8 will be described with reference to the features of FIG. 2, the exemplary embodiments are not limited thereto. In operation 8000, the data collecting unit 322 may initialize a content attribute information structure, content_data, to be transferred to the data processing unit 324. In operation 8010, it is determined whether a content_data is a database table item. The data collecting unit 322 may determine whether a content_data is a database table item by determining if a data source of the content_data is acquired from the database table. If the content_data is not a database table item, i.e., the data source of the content_data is not acquired from the database table, in operation 8020, an input path, e.g., a file route on the file system, of content_data is input into a route field within CONTENT_INFO of the content attribute information. In operation 8040, the content_data is transferred. For content_data for which an input path was input the remaining values of the content_data may be determined to be a NULL state and transferred to the data processing unit 324. If the content_data is a database item, i.e., data source of the content_data is acquired from the database table, in operation 8030, information from content_data is input into the fields of CONTENT_TYPE and CONTENT_VALUE. In operation 8040, the content_data is transferred. The route field within CONTENT_VALUE may be processed as a NULL state and transferred to the data processing unit 324.

FIG. 9 is a diagram of content attribute information according to an exemplary embodiment of the present invention.

Although FIG. 9 will be described with reference to the features of FIG. 2, the exemplary embodiments are not limited thereto. The data collecting unit 322 may determine an arrangement type 9000 for the item list displayed by the music player. For example, the arrangement type 9000 may classify music according to the following values:
Audio: shows all music content which can be executed by the device.
Artist: shows music content that belongs to a reference artist name.
Album: shows music content that belongs to a reference album name.
Genre: shows music content that belongs to a reference genre name.

The data collecting unit 322 acquires CONTENT_TYPE 9010 which is a value to connect a reference table within a database table 9020 managed by the operating system with the arrangement type 9000 through the arrangement type 9000. Matching of the arrangement type 9000, and CONTENT_TYPE 9010 and the database table 9020 is shown in FIG. 9.

If the music player is an Audio arrangement type, MediaStore_Audio.Media is input into CONTENT_TYPE 9010 and the following value is input into CONTENT_INFO. In other words, as a field value, “_data” indicating a storing position of a corresponding file is input into an Audio Table of the database, and “mnt/sdcard/music/sample.mp3” indicating a storing position on the device is input into a field value. A data structure transferred from the data collecting unit 322 to the data processing unit 324 through the aforementioned process is as follows:

content_Data
{
content_Type = “MediaStore_Audio.Media”;
content_Value.field = “_data”;
content_Value.field_Value = “mnt/sdcard/music/sample.mp3”;
}

FIG. 10 is a diagram of a data processing unit according to an exemplary embodiment of the present invention.

Although FIG. 10 will be described with reference to the features of FIG. 2, the exemplary embodiments are not limited thereto. The data processing unit 324 may be configured as an object within the operating system and may provide a remote interface of a service type to access the object. Applications may access the data processing unit 324 through the remote interface. The data collecting unit 322 may transmit data through an interface provided by the data processing unit 324.

The data processing unit 324 includes a data analyzing unit 3240, a short-cut icon registering unit 3242, an icon generating unit 3244, a short-cut icon placing unit 3246, and a short-cut data storage 3248.

The data analyzing unit 3240 may be configured to acquire the content attribute information to generate the short-cut icon, and to identify a database table name by analyzing the acquired content attribute information. The short-cut icon registering unit 3242 may be configured to receive the database table name and the content attribute information analyzed by the data analyzing unit 3240 and to store and to update short-cut icon attribute information in the short-cut data storage 3248 according to the received information. The short-cut data storage 3248 may be a database locally managed by the data processing unit 324. The short-cut icon attribute information stored in a table of the short-cut data storage 3248 may include a short-cut icon name, a database table name, a database table field, and database table field value information, etc. The icon generating unit 3244 may be configured to generate the short-cut icon according to the short-cut icon attribute information of the short-cut data storage 3248 registered through the short-cut icon registering unit 3242. The short-cut icon placing unit 3246 may be configured to places the short-cut icon generated through the icon generating unit 3244 at a reference position of the user interface.

FIG. 11 is a flowchart of a method for operation of a data analyzing unit and the short-cut icon registering unit according to an exemplary embodiment of the present invention.

Although FIG. 11 will be described with reference to the features of FIG. 10, the exemplary embodiments are not limited thereto. The data analyzing unit 3240 may be configured to analyze the data received from the data collecting unit 322 of the application terminal and to transfer the analyzed data to the short-cut icon registering unit 3242. In operation 1100, the data analyzing unit 3240 verifies a value of CONTENT_TYPE of the content attribute information received from the data collecting unit 322. If the value of CONTENT_TYPE is known, the table name within the database may be extracted and the database table name may be transferred to the short-cut icon registering unit 3242 with the content attribute information received from the data collecting unit 322.

The data analyzing unit 3240 extracts the database table name by using the following method. In operation 1110, it is determined if the value of CONTENT_TYPE within the content attribute information is Null. If the value of CONTENT_TYPE is Null, the value of CONTENT_TYPE is determined from the received file route value and the method proceeds to operation 1130. In operation 1130, a file extension is extracted from the file route value. In operation 1140, it is determined whether the file extension is an analyzable extension. If the extension is analyzable, the value of CONTENT_TYPE is determined by using the corresponding value. In operation 1150, the database table name may be determined through the extension, i.e., the value of CONTENT_TYPE. In operation 1160, the CONTENT-TYPE is filled in as the value of CONTENT_INFO. The file route value is present as a _data field within the database table. The field value of CONTENT_INFO may be set as _data and Field_Value may be input as the file route value and thereafter, Field_Value may be transferred to the short-cut icon registering unit 3242. If the value of CONTENT_TYPE within the content attribute information is not Null in operation 1110, in operation 1120, the database table name associated with the value of CONTENT_TYPE is determined through a matching process, and the database table name is transferred to the short-cut icon registering unit 3242 together with the content attribute information.

In operation 1170, the data analyzing unit 3240 analyzes the CONTENT_INFO. In operation 1180, the short-cut icon registering unit 3242 matches the short-cut icon and a title value if the short-cut icon is to be generated by analyzing the content attribute information received from the data analyzing unit 3240. In operation 1190, the short-cut data is saved in the short-cut data storage 3248. In detail, the short-cut icon registering unit 3242 updates the short-cut icon attribute information of the short-cut icon which may be newly generated in a short-cut data table type in the short-cut data storage 3248.

FIG. 12 is a diagram of a table preparation method according to an exemplary embodiment of the present invention.

Although FIG. 12 will be described with reference to the features of FIG. 10, the exemplary embodiments are not limited thereto. If a plurality of items are selected by the user, the short-cut icon registering unit 3242 may be configured to add the short-cut icon attribute information to the short-cut data table and to generate a new group and adds information according to the generated group to a group table 1200. The group table 1200 may have fields of GROUP_ID and GROUP_NAME. GROUP_ID may be a value used to differentiate each group and GROUP_NAME may be used as a value of Title if a group short-cut icon is generated on the device. A relationship between the group table 1200 and the short-cut data table 1210 may be generated by matching GROUP_ID within the group table 1200 and a value of GROUP within the short-cut data table 1210. If a reference item within the short-cut data table 1210 belongs to a reference group, the GROUP field may correspond to the value of GROUP_ID within the group table 1200 and if not, −1 is used to indicate no GROUP was found.

Attribute information may be stored in the short-cut data table 1210 for each short-cut icon. SHORTCUT NAME may be a value used as Title of the short-cut icon to be displayed on the screen of the device 1 and may have names that represent characters of the corresponding short-cut icons, such as names of a file route, Mime-type, Contact, and the like. GROUP may be matched with GROUP_ID of the group table 1200. TABLE may be a reference table name of the database table. FIELD may be one field name among a plurality of fields of the table name. A value corresponding to the field name may be a FIELD_VALUE. The short-cut icon registering unit 3242 may insert data for a new short-cut icon into the short-cut data storage 3248 and transfers the data to the icon generating unit 3244.

FIG. 13 is a flowchart of a method for operation of an icon generating unit and the short-cut icon placing unit according to an exemplary embodiment of the present invention.

Although FIG. 13 will be described with reference to the features of FIG. 10, the exemplary embodiments are not limited thereto. The icon generating unit 3244 may substitute the short-cut icon attribute information in SHORTCUTINFO which may be a structure to generate the short-cut icon on a device screen by using the data received from the short-cut icon registering unit 3242. In operation 1300, the icon generating unit 3244 matches the short-cut icon attribute information with variables of the icon generating unit 3244, and initializes the short-cut icon attribute information. In operation 1310, the icon generating unit 3244 generates short-cut information associated with the initialized short-cut icon attribute information. In operation 1320, the icon generating unit 3244 determines if multiple short-cut icons are to be provided. If multiple short-cut icons are to be provided, in operation 1330, a short-cut folder is initialized. In operation 1340, a short-cut folder is generated and the multiple short-cut icons are inserted into the folder. In operation 1350, it is determined if the generation of the short-cut icon succeeded. If the short-cut icon was not successfully generated, in operation 1360 an error message is displayed. If the short-cut icon was successfully generated, in operation 1370, the information about the generated short-cut icon is transferred to the short-cut icon placing unit 3246.

In operation 1370, the short-cut icon placing unit 3246 switches the screen from an application launching screen into a screen which the user may access, such as the home screen. In operation 1380, the short-cut icon placing unit 3246 places the short-cut icon on the switched screen. The short-icon received from the icon generating unit 3244 and the folder-type short-cut icon may be disposed together on the screen.

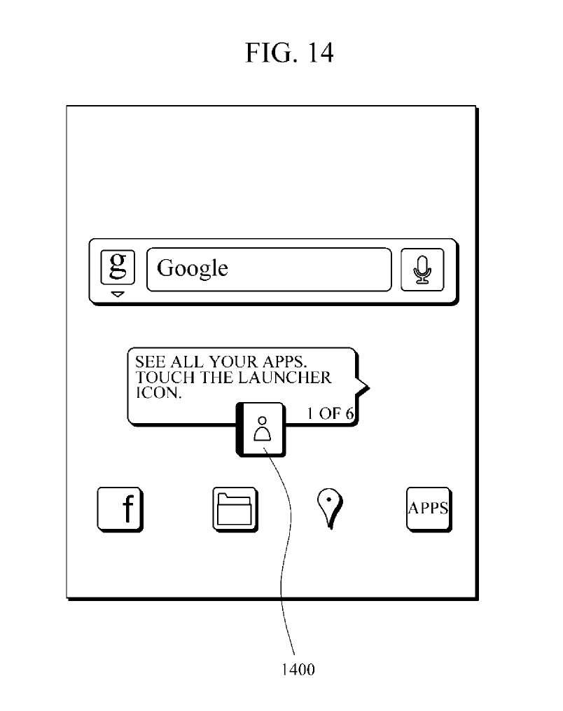

FIG. 14 is a diagram of a screen displaying short-cut icons according to an exemplary embodiment of the present invention. Although FIG. 14 will be described as if generated by the features of FIG. 10, the exemplary embodiments are not limited thereto.

Referring to FIG. 14, the short-cut icon placing unit 3246 may dispose the icon received from the icon generating unit 3244 or a folder-type short-cut icon 1400 on the screen of the device 1. The short-cut icon may be placed on a home screen. In FIG. 14, illustrates the short-cut icon disposed at the center of the home screen. The short-cut icon may be disposed on the home screen in order to improve user convenience. The user may execute contents of applications of the short-cut icon directly without an application launching process through the short-cut icon disposed on the home screen.

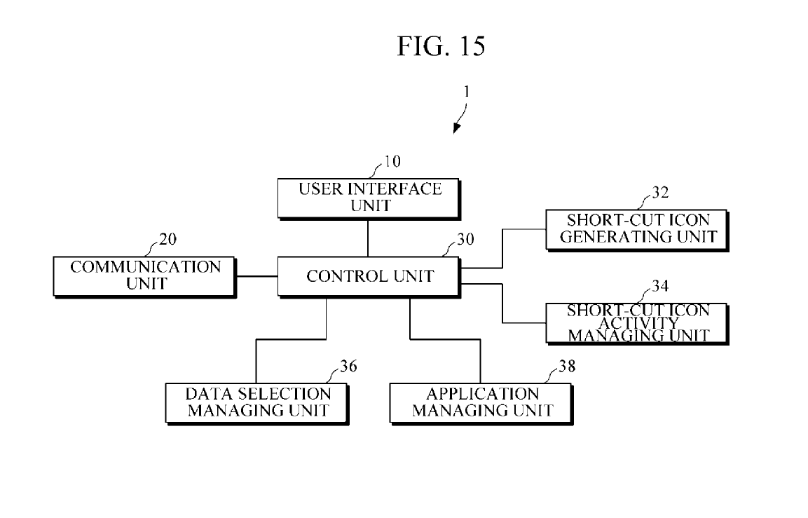

FIG. 15 is a diagram of a portable device according to an exemplary embodiment of the present invention.

The device 1 may further include a short-cut icon activity managing unit 34, a data selection managing unit 36, and an application managing unit 38. The short-cut icon activity managing unit 34, the data selection managing unit 36, and the application managing unit 38 may be formed in the framework terminal in a software structure of the device 1 but are not limited thereto. The components of FIG. 15 may be components that operate based on an Android operating system, but are not limited thereto and may be components in other operating systems.

The description of the short-cut icon generating unit 32, the user interface unit 10, the control unit 30, and the communication unit 20 are similar to the description in FIG. 1 and a detailed description thereof will be omitted. If the short-cut icon activity managing unit 34 detects selection of the short-cut icon by the user, the short-cut icon activity managing unit 34 may execute the corresponding contents of the application associated with the short-cut icon by using the short-cut icon attribute information of the short-cut icon.

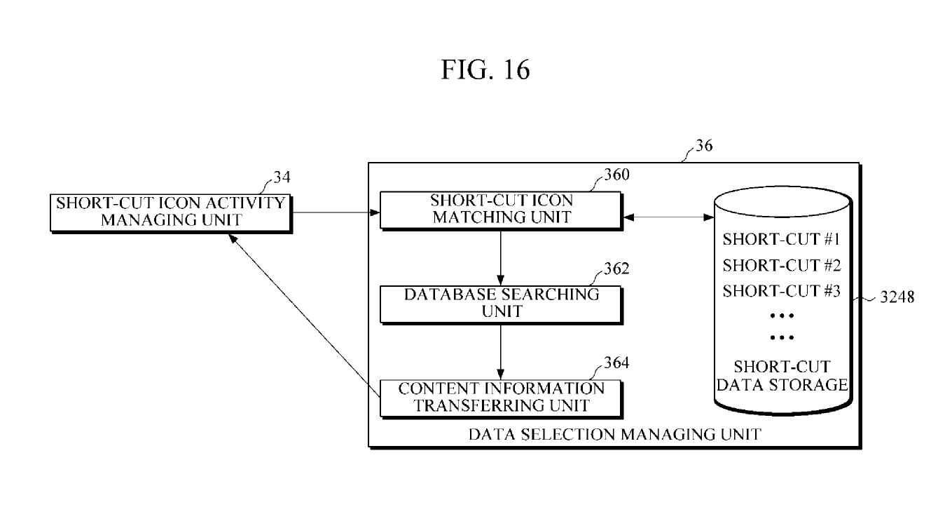

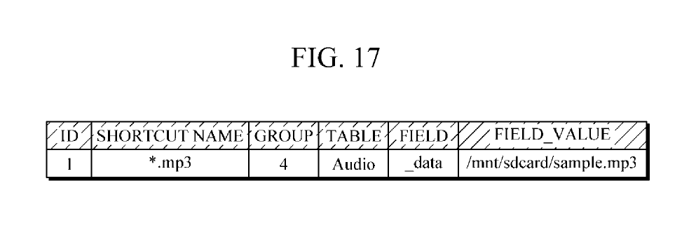

The data selection managing unit 36 may be configured to receive a short-cut icon name from the short-cut icon activity managing unit 34 and to search the short-cut icon attribute information associated with the corresponding short-cut icon in the database table, and may transfer the searched short-cut icon attribute information to the short-cut icon activity managing unit 34. In other words, the data selection managing unit 36 may be configured to receive the short-cut icon name from the short-cut icon activity managing unit 34, and to search the short-cut icon attribute information associated with the short-cut icon in the short-cut data storage 3248. The content data stored in the database table may be searched by using the searched short-cut icon attribute information. The searched content data and short-cut icon attribute information may be transferred to the short-cut icon activity managing unit 34. The short-cut icon activity managing unit 34 may execute the contents of the searched content data by using the information received from the data selection managing unit 36. The short-cut icon activity managing unit 34 and the data selection managing unit 36 will be described below in FIG. 16 and FIG. 17.

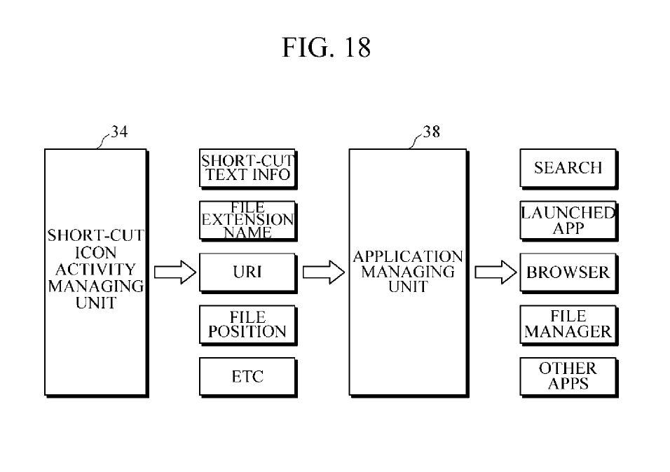

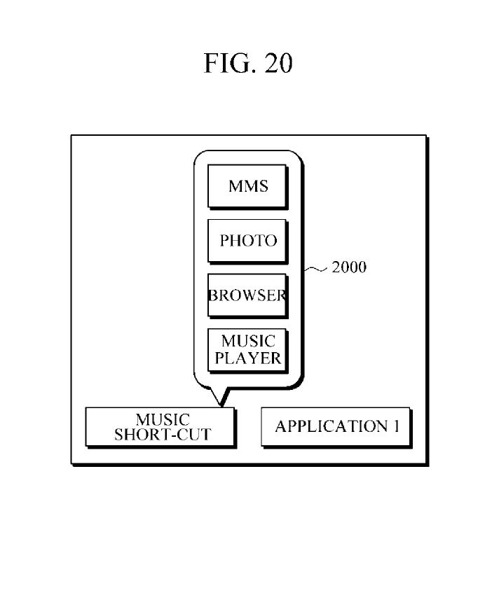

The application managing unit 38 may be configured to acquire and manage information of an application of the device 1. The application may be preloaded on the device 1 or downloaded therein. The application managing unit 38 may provide the user interface unit 10 with a list of applications that may execute contents by using the short-cut icon attribute information of the item and the short-cut icon. The short-cut icon may be generated by the short-cut icon activity managing unit 34. An example of providing the application list using the application managing unit 38 will be described below in FIG. 18 and FIG. 20.

FIG. 16 is a diagram of a short-cut icon activity managing unit and a data selection managing unit according to an exemplary embodiment of the present invention.

Although FIG. 15 will be described with reference to the features of FIG. 16, the exemplary embodiments are not limited thereto. If the short-cut icon is selected by the user through a screen of device 1 as illustrated in FIG. 14, the short-cut icon activity managing unit 34 may be configured to transfer the short-cut icon name to the data selection managing unit 36 to collect corresponding information in order to collect short-cut icon information, i.e., information included in the short-cut icon.

The data selection managing unit 36 includes a short-cut icon matching unit 360, a database searching unit 362, and a content information transferring unit 364.

The short-cut icon matching unit 360 may be configured to search for the short-cut icon attribute information stored in the short-cut data storage 3248 by using the name of the short-cut icon selected by the user. A query for a search may be, for example, SELECT*From “Short-cut Table” where “Shortcut Name=Short-cut Name.” Where, Short-cut Table is the table name of the database managed by the short-cut data storage 3248, and Short-cut Name is a name of the short-cut icon which the user intends to execute. The short-cut icon attribute information (see FIG. 17) corresponding to the name of the short-cut icon may be acquired from the short-cut data storage 3248 through the query.

FIG. 17 is a diagram of short-cut icon attribute information according to an exemplary embodiment of the present invention.

Although FIG. 17 will be described with reference to the features of FIG. 15, the exemplary embodiments are not limited thereto. The short-cut icon attribute information is information stored if the short-cut icon registering unit 3242 of the data processing unit 324 registers the short-cut icon and the information may be extracted from the database managed by the operating system by using the short-cut icon attribute information. Referring to FIG. 17, information which may be acquired from the short-cut icon attribute information is as follows. TABLE may be a table name storing information associated with the short-cut icon within the database table, FIELD may be a reference field name within the database table representing the short-cut icon, and FIELD_VALUE may be a value corresponding to the reference FIELD.

The database searching unit 362 may acquire information on the contents corresponding to the short-cut icon by using the short-cut icon attribute information acquired by the short-cut icon matching unit 360. The query thereof may be, for example, SELECT*From “Audio” Where”_data=/mnt/sdcard/sample.mp3. All data information corresponding to mnt/sdcard/sample.mp3 which is _data may be acquired from the Audio table through the query.

The content information transferring unit 364 may bind the information acquired by the database searching unit 362 into array-type data, and may transfer the bound data to the short-cut icon activity managing unit 34. For example, information about music content may include a music name, an artist name, an album name, a storing position of album Art, a file route, and the like, and the short-cut icon activity managing unit 34 may launch a reference application by using the information or transfers data regarding the application selected by the user to the application managing unit 38, which processes the transferred data.

FIG. 18 is a diagram of a method for generating an application list according to an exemplary embodiment of the present invention.

Although FIG. 15 will be described with reference to the features of FIG. 18, the exemplary embodiments are not limited thereto. The application managing unit 38 may receive information associated with the content in the short-cut icon activity managing unit 34 and may configure an application list associated with the corresponding contents. For example, the short-cut icon activity managing unit 34 may transfer SHORT-CUT ICON TEXT INFORMATION, a FILE EXTENSION NAME, URI, a FILE POSITION, and the like to the application managing unit 38. The application managing unit 38 provides icons for a LAUNCHED APPLICATION, a SEARCH FUNCTION, a BROWSER, a FILE MANAGER, and OTHER APPLICATIONS which may execute the contents corresponding to the short-cut icon. The application managing unit 38 may determine application launching attributes which can be executed with respect to applications, and may be provided to the user interface for application launching. An example of the application list will be described below in FIG. 20.

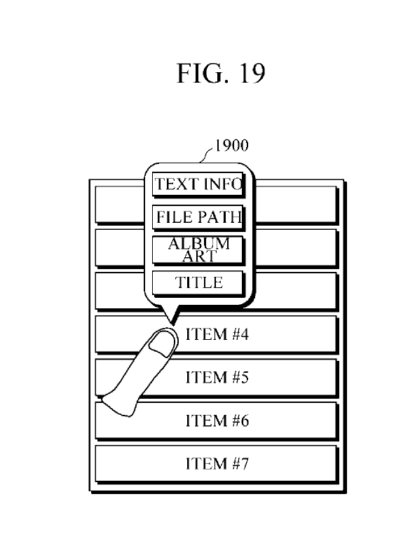

FIG. 19 is a diagram of a screen according to an exemplary embodiment of the present invention.

Although FIG. 19 will be described with reference to the features of FIG. 15, the exemplary embodiments are not limited thereto. The short-cut icon activity managing unit 34 of FIG. 15 may allow the user to select information of the short-cut icon if providing the short-cut icon for the contents. Selectable information may be information about the content. For example, if the content is music contents, the selectable information may include TEXT INFORMATION, a FILE PATH, ALBUM ART, and TITLE, as illustrated in reference numeral 1900. Selectable information of music content may also include Artist name, album name, album position, and the like. The short-cut icon registering unit 3242 may register the selected information in the short-cut data storage 3248 as one short-cut icon. The application managing unit 38 may drive the application by using the information of the short-cut icon if the corresponding short-cut icon is selected.

FIG. 20 is a diagram of a screen according to an exemplary embodiment of the present invention.

Although FIG. 20 will be described with reference to the features of FIG. 15, the exemplary embodiments are not limited thereto. FIG. 20 depicts a screen of device 1 displaying an application list. In order to execute the short-cut icon, the application managing unit 38 may display an application list of applications capable of processing content information of the short-cut icon through the screen of device 1 by analyzing the information of the short-cut icon. A function provided by the application selected by the user in the application list may be executed. For example, if the user selects the short-cut icon for the music contents as shown in FIG. 20, an application list of applications which can interact with the music contents is prepared and displayed on the screen by analyzing information of the music content. The user may select and launch a reference application in the application list. The application list may be MUSIC PLAYER, BROWSER, PHOTO, and MMS (Multimedia Messaging Service) as shown in reference numeral 2000. The user may select to play the corresponding music content by using the file route which the short-cut icon has at the time of selecting Music Player. If BROWSER is selected, an Internet search function may be provided by using Title, Artist name, Album name, and the like. If PHOTO is selected, a photograph may be displayed by using positional information of Album Art. IF MMS is selected, a MMS message may be prepared and the corresponding music may be attached to the MMS message by using the file route.

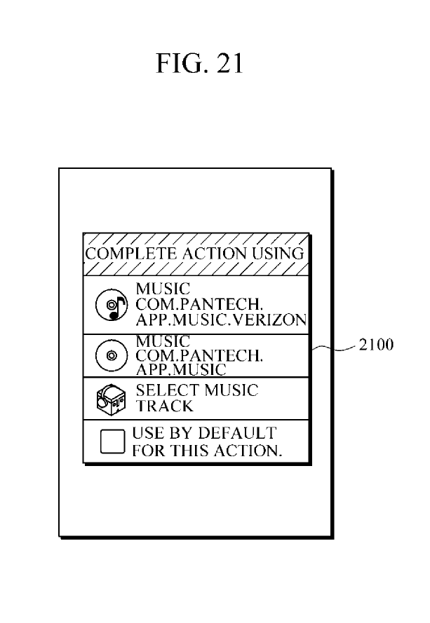

FIG. 21 is a diagram of a screen according to an exemplary embodiment of the present invention.

FIG. 21 illustrates the launching of an application using information of content corresponding to a short-cut icon. If a user selects the short-cut icon for content, for example music content, a menu window of applications which can perform a music playing function may be displayed as shown in reference numeral 2100 of FIG. 21.

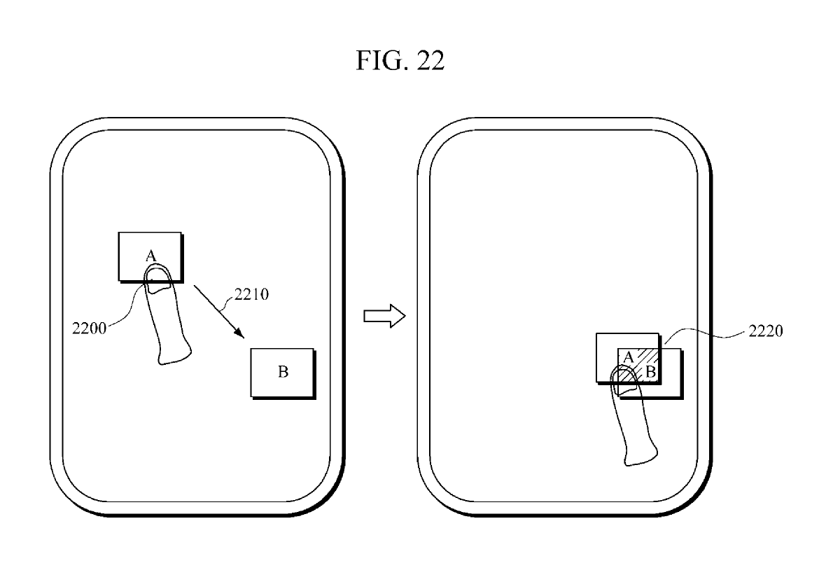

FIG. 22 is a method for executing contents according to an exemplary embodiment of the present invention.

FIG. 22 illustrates a user executing contents by designating an application to execute the contents corresponding to a short-cut icon. Referring to FIG. 22, in operation 2200, the user may select a short-cut icon A on the screen. In operation 2210, the user may drag p the selected short-cut icon and, in operation 2220, the user may drop the selected short-cut icon onto the application B that the user selects to launch the content of the short-cut icon A. The application managing unit 38 may analyze features of the application selected by the user, e.g., types of processable contents, an action, and filter information to execute the contents by using processable information from among the information of the short-cut icon.

Aspects of the present invention can be implemented as computer readable codes in a non-transitory computer readable record medium. Non-transitory computer readable record media may include all types of record media in which computer readable data may be stored. Examples of non-transitory computer readable record media include a ROM, a RAM, a CD-ROM, a magnetic tape, a floppy disk, and an optical data storage. In addition, non-transitory computer readable record media may be distributed to computer systems over a network, in which computer readable codes may be stored and executed in a distributed manner.

According to exemplary embodiments of the present invention, a short-cut icon for contents is provided, and contents can be executed directly without an application launching process. An application function may be performed by using various pieces of information included in the contents at the time of providing the short-cut icon and the user may use other application functions associated with the contents at the time of selecting the contents.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A portable device, comprising:
a short-cut icon generating unit configured to generate a short cut icon of a first application;
a user interface configured to display the short-cut icon,
wherein if the short-cut icon is selected, the user interface displays a menu of at least one of a content of the first application, a launch application icon, a launch browser icon, a file manager icon, and an application list of other applications that execute the content of the first application.

2. The portable device of claim 1, wherein the short-cut icon generating unit comprises:
a data collecting unit to collect content attribute information of the first application;
a data processing unit to generate the short-cut icon of the first application according to the content attribute information; and
a user interface controlling unit to control the user interface to display content attribute information of the first application or contents of the first application.

3. The portable device of claim 2, wherein the content of the first application is information for direct execution of the first application and the content attribute information is information related to the first application but not needed to directly execute the first application.

4. The portable device of claim 1, wherein the user interface controlling unit is configured to display an item list if the first application is launched.

5. The portable device of claim 2, wherein the data processing unit collects content attribute information by:
receiving an index of information related to the first application;
determining a data source of the index of the information related to the first application; and
collecting content attribute information according to the data source.

6. The portable device of claim 1, further comprising:
a data selection managing unit configured to collect short-cut icon attribute information.

7. The portable device of claim 6, further comprising: a short-cut icon activity managing unit configured to generate an icon and to execute a content of short-cut icon according to short-cut icon attribute information.

8. The portable device of claim 7, further comprising: an application managing unit configured to collect and to manage an application list of applications capable of processing content information of the short-cut icon by analyzing the content of the short-cut icon.

9. A method for providing a short-cut icon, comprising:
receiving a request to generate a short-cut icon for a first application;
collecting content attribute information of the first application;
generating a short-cut icon of the first application according to the content attribute information of the first application; and
displaying the short-cut icon.

10. The method of claim 9, wherein generating a short-cut icon of the first application according to the content attribute information of the first application, comprises:
analyzing the content attribute information of the first application;
generating short-cut icon attribute information according to the analyzed content attribute information of the first application;
generating a short-cut icon according to short-cut icon attribute information.

11. The method of claim 10, wherein generating a short-cut icon according to short-cut icon attribute information comprises:
initializing the short-cut icon attribute information;
generating short-cut icon according to the initialized short-cut icon attribute information;
determining if a plurality of short-cut icons are requested by a user; and
if a plurality of short-cut icons are requested, generating a folder including the short-cut icon.

12. The method of claim 9, wherein collecting content attribute information of the first application comprises:
receiving an index of information related to the first application;
determining a data source of the index of the information related to the first application; and
collecting content attribute information according to the data source.

13. The method of claim 9, wherein generating a short-cut icon of the first application according to the content attribute information of the first application comprises:
generating content of the short-cut icon according to the short-cut icon attribute information;
executing content of the short-cut icon; and
generating an icon according to the content of the short-cut icon,
wherein displaying the short-cut icon comprises displaying at least one of a launch application icon, a launch browser icon, a file manager icon, and an application list of other applications that execute the content of the first application.

14. The method of claim 9, wherein content attribute information comprises at least one of a launch application icon, a launch browser icon, a file manager icon, and an application list of other applications that execute the content of the first application.

15. A method of executing a short-cut icon in a portable device, comprising:
selecting a short-cut icon of a first application;
moving the short-cut icon to be disposed on a second short-cut icon of a second application;
executing a content of the first application according to the second application,
wherein the short-cut icon includes a content of the first application and content attribute information of the first application not used to directly execute the first application.

16. The method of claim 15, wherein content attribute information comprises at least one of a launch application icon, a launch browser icon, a file manager icon, and an application list of other applications that execute the content of the first application.

17. The method of claim 15, wherein content of the first application comprises information for direct execution of the first application.
